(19) United States
(12) Patent Application Publication
(10) Pub. No.: US 2014/0189708 A1
(43) Pub. Date: Jul. 3, 2014

(54) TERMINAL AND METHOD FOR EXECUTING APPLICATION IN SAME

(71) Applicant: SAMSUNG ELECTRONICS CO., LTD., Suwon-si, Gyeonggi-do (KR)

(72) Inventors: Il Ho Lee, Suwon-si (KR); Jeong Ig Song, Seoul (KR); In Choon Yeo, Suwon-si (KR); Young Woo Ahn, Yongin-si (KR)

(21) Appl. No.: 14/237,475

(22) PCT Filed: Aug. 17, 2012
(86) PCT No.: PCT/KR2012/006573

§ 371 Date: Feb. 6, 2014

(30) Foreign Application Priority Data
Aug. 17, 2011 (KR) 10-2011-0081775

(51) Int. Cl. G06F 9/50

(52) U.S. Cl. CPC G06F 9/505
USPC 718/104

(57) ABSTRACT

The present invention relates to a terminal and a method for executing an application in the same, including the steps of: confirming the weight of the application when a code of the application to be executed is inputted; calculating an allocation index using the confirmed weight; selecting a processing device for executing the application between a central processing unit and a graphics processing unit through the calculated application index; and executing the application through the selected processing device. Accordingly, the present invention determines whether the execution of the application is assigned to the central processing unit or the graphics processing unit according to the weight designated by the user. Thus, the present invention can prevent the tipping effect of the workload only to one processing unit which is caused by an increase in the degree of freedom for the workload distribution.

### TECHNICAL FIELD

The present invention relates to a terminal and method for executing an application therein and, in particular, to a terminal including a Central Processing Unit (CPU) and a Graphics Processing Unit (GPU) and a method for executing an application by selecting a processing unit to execute the application.

### BACKGROUND ART

As recently as early 1990s, a graphic card mounted on the terminal such as computer is recognized as a part such as an adapter for outputting screen by converting the operation result to picture or text signal. However, as the multimedia contents, particularly games, have received attention since middle 1990's, the role of the graphic card has changed gradually.

In more detail, 3D graphic has been introduced rapidly, and various effect and texture expression technologies have been developed to provide more realistic view of the screen. Such technologies are characterized by the processing load too large to be processed with a single CPU. For this reason, GPU as a dedicated graphic processor has been developed to assist the CPU.

Although the GPU was used as the device for graphics operation, the recent GPU has been developed to the extent of processing general operations and thus called General-Purpose computing on Graphics Processing Units (GPGPU). The GPGPU is suitable for the parallel programs in view of the characteristics of the multi-core structure. Typically, the CPU and the GPU may share the same memory or have different memories depending on their implementation. That is, the CPU and the GPU may have respective memories connected through an external BUS or share the same memory.

With the advance of the performance of GPU, many searches are conducted on the methods for allocating task allocation between the CPU and GPU. Among them, the Adaptive mapping of Qilin is a representative method allocating tasks to the CPU and the GPU according to the application execution time stored depending on the data size. The adaptive mapping method performs training run on the CPU and the GPU before executing the application actually.

At this time, the data size is determined through sampling, and the training run execution result is stored in a database. When executing the application actually, the DB is referenced to check the processing unit having the shortest application execution time. Then the corresponding application task is allocated to the checked processing unit.

### DISCLOSURE OF INVENTION

### Technical Problem

However, the method of selecting the processing unit to perform the application using the application execution time pre-stored in the database needs to update the data base through the training run. In this case, the training run in itself may be undesirable overhead of the system operation. In the case that the training run and the real program operation execution environments are different from each other, the workload varies depending on the operation conditions of the CPU and the GPU and thus the time information stored in the database may become unreliable. Also, the adaptive mapping method of Qilin considers only the execution speed of one program, and this means no consideration of load balancing of the CPU/GPU such that it may occur that processing unit continues executing tasks. The present invention proposes a terminal and a method of executing an application using a processing unit selected depending on the application running on the terminal

### Solution to Problem

In accordance with an aspect of the present invention, an application execution method of a terminal having a central processing unit and a graphics processing unit includes calculating an allocation index using a weight of an application to be executed, selecting one of the central and graphics processing units to execute the application based on the allocation index, and executing, at the selected processing unit, the application.

Preferably, the selecting of one of the processing units includes checking a priority processing mode for selecting the processing unit to which the application is allocated and a processing threshold value according to the priority processing mode and selecting the processing unit by comparing the checked processing threshold value and the allocation index.

Preferably, the selecting of one of the processing units includes compiling, when the allocation index is less than the processing threshold value, the code of the application in order for the central processing unit to process the application.

Preferably, the selecting of one of the processing units includes compiling, when the allocation index is equal to or greater than the processing threshold value, the code of the application in order for the graphic processing to process the application.

In accordance with another aspect of the present invention, a terminal for executing an application includes a storage unit which stores data, a central processing unit which calculates an allocation index using a weight of an application to be executed and selects one of the central and graphics processing units to execute the application based on the allocation index, and a graphics processing unit which executes the application using a binary transmitted by the central processing unit.

Preferably, the central processing unit checks a priority processing mode for selecting the processing unit to which the application is allocated and a processing threshold value according to the priority processing mode and selects the processing unit by comparing the checked processing threshold value and the allocation index.

Preferably, the central processing unit compiles, when the allocation index is less than the processing threshold value, the code of the application in order for the central processing unit to process the application.

Preferably, the central processing unit compiles, when the allocation index is equal to or greater than the processing threshold value, the code of the application in order for the graphic processing to process the application.

### Advantageous Effects of Invention

According to the present invention, the user determines whether to allocate application execution to the CPU or the GPU based on a designated weight. This improves the degree of freedom for workload distribution so as to prevent the workload from being biased to one processing unit. Also, this negates the necessity of updating execution time of each application in the database, resulting in reduction of update overhead.

### BRIEF DESCRIPTION OF DRAWINGS

FIG. 1 is a block diagram illustrating a configuration of a terminal according to an embodiment of the present invention.

FIG. 2 is a diagram illustrating the workload balancing information table according to an embodiment of the present invention.

FIG. 3 is a diagram illustrating workloads of the application which is allocated in a first priority mode according to an embodiment of the present invention.

FIG. 4 is a diagram illustrating workloads of the application which is allocated in the second priority mode according to an embodiment of the present invention.

FIG. 5 is a flowchart illustrating an application execution method according to an embodiment of the present invention.

### MODE FOR THE INVENTION

The terminal means an information processing device capable of generating data and processing data exchanged with the outside. The terminal may be any of a computer, a notebook, a tablet PC, a portable terminal, and a smartphone; and at least two processing units include a CPU and a GPU.

The CPU is literally the device processing all data at the center of the terminal which interprets and executes the command input by the user and outputs the execution result. The most basic role of the CPU is operation/computation.

The GPU is responsible for graphics of the terminal which mainly processes 3D graphics. Accordingly, when the terminal equipped with a GPU executes graphic-related operations, the workload of the CPU is relieved. Since the GPU is also capable of processing large volume of matrixes and vectors, it is possible to execute the applications using such operations.

Task is a unit of internal processing of the terminal and denotes the execution content of an application requiring resources such as input/output system program and central processor. When applications are executed, they are sorted into several tasks for efficient utilization of the resource of the terminal

The compiler or compile denotes a program or process converting an application programed with high-level language to a target application in a format executable at the terminal immediately that is equivalent with the source application in meaning. That is, a certain application has to be changed into a format of a language which the terminal is capable of understand immediately. The program responsible for this function is the compiler.

The application input to be compiled is called primitive application, and the language used for programing the primitive application is called source code. The compiled application is called target application, and the language used for programing the target application is called object language or target language. If an application is compiled into a target application, it may be performed repetitively as far as the primitive application is not modified.

The term ‘binary’ denotes that there are two possible outcomes of 0 and 1 and means an execution file for executing an application. That is, the terminal compiles the source code of the application selected by the user for execution into the target code and, as a consequence, a binary for executing the corresponding application is generated.

The term ‘workload’ denotes the load to be processed by the CPU and the GPU.

Exemplary embodiments of the present invention are described with reference to the accompanying drawings in detail. Detailed description of well-known functions and structures incorporated herein may be omitted to avoid obscuring the subject matter of the present invention. Further, the following terms are defined in consideration of the functionality in the present invention, and may vary according to the intention of a user or an operator, usage, etc. Therefore, the definition should be made on the basis of the overall content of the present specification.

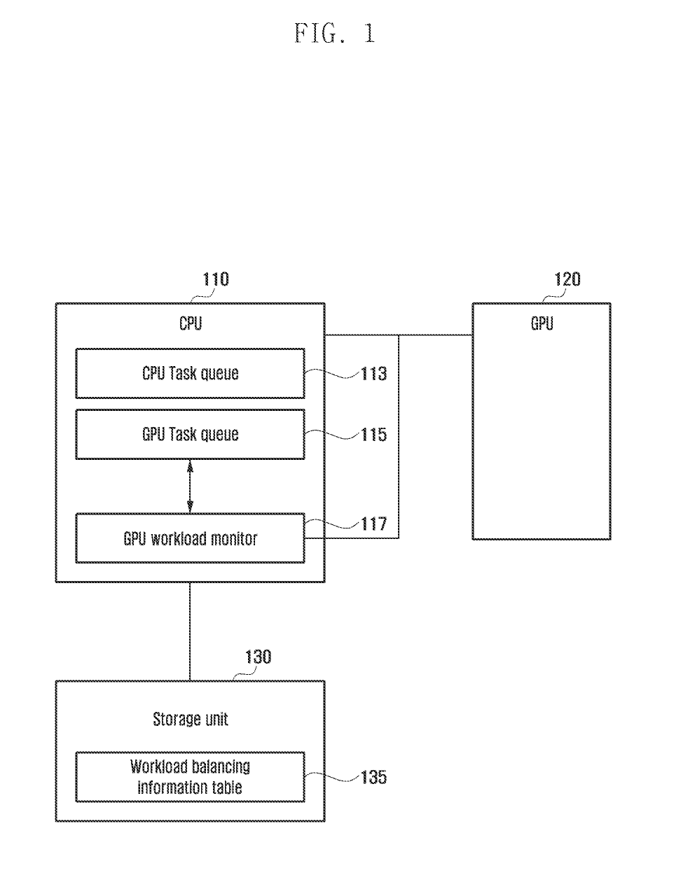

FIG. 1 is a block diagram illustrating a configuration of a terminal according to an embodiment of the present invention.

Referring to FIG. 1, the terminal includes a CPU 110, a GPU 130, and a storage unit 130.

The CPU 110 is responsible for controlling overall operations and states of the components constituting the terminal. The CPU is literally the device processing all data at the center of the terminal which interprets and executes the command input by the user and outputs the execution result. The most basic role of the CPU is operation/computation. For example, if the user input a command of executing 0+1, the CPU 110 computes the input to output 1 as a result.

The CPU 110 may include a CPU task queue 113, a GPU Task queue 115, and a GPU workload monitor 117. The CPU Task queue 113 may store the task information of the application running on the CPU 110 while the application is running The GPU Task queue 115 may store the task information of the application running on the GPU 120 while the application is running. Next, the workload monitor 117 analyzes the workload of the GPU 120 while monitoring the state of the GPU 120.

In the present invention, the CPU 110 selects a processing unit for processing the application according to the configured weight of the application and controls the selected processing unit to process the application. At this time, the processing unit means the CPU 110 or GPU 120.

In more detail, if an application is selected, the CPU 110 input a primitive code of the selected application. Next, the CPU 110 checks the weight information on the application corresponding to the input primitive code. Here, the weight information is checked by referencing a preconfigured workload balancing information table 135. Here, the workload balancing information table 135 includes the weight information on the corresponding application and is stored in the storage unit 130. The CPU 110 calculates an allocation index using the checked weight information. The allocation index may is calculated as equation (1).

WI(allocation index)=αX1+βX2+γX3+δX4+εX5+ . . . +ωXn (1)

Here, X1, X2, X3, . . . , Xn denotes the weight information included in the workload balancing information table as the values configured for the condition (X) for executing the application. Also, α, β, γ, δ, . . . , ω denote per-condition weights.

For example, it is assumed that that the index of the application running currently on the CPU (X1) is 0.4, the index of the application running currently on the GPU (X2) is 0.3, the index of the data size processed by the application to be executed (X3) is 0.8, the index of current workload of the GPU (GPU usage) (X4) is 0.5, the weight of X1 item (α) is 0.2, the weight of X2 item (β) is 0.2, the weight of X3 item (γ) is 0.5, and the weight of X4 item (δ) is 0.1. In this case, the allocation index is calculated to be 0.59 through equation (1).

The allocation index calculated by the equation has a value in the range from 0 to 1. The CPU 110 may select the processing unit for executing the corresponding application based on the allocation index calculated as above. In order to accomplish this, the CPU 110 has to check the configured priority mode.

The priority mode is the operation mode for selecting a processing threshold value for determining whether to execute the application with the CPU or the GPU. Accordingly, the priority processing mode may be classified into at least two modes. The processing threshold value is configured per mode.

The processing threshold value for determining the processing unit to process the corresponding application changes depending on the configured priority mode. The priority mode and per priority mode processing threshold value are included in the workload balancing information table 135.

After checking the priority mode, the CPU 110 reads the processing parameter depending on the priority mode. Next, the CPU 110 determines whether the calculated allocation index is less than the checked processing threshold value. If the allocation index is less than the processing threshold value, the CPU 110 compiles the application source code to the target code to be processed by the CPU 110. Otherwise if the application index is equal to or greater than the threshold value, the compiles the application source code to the target code to be processed by the GPU 120. If the application is of being processed by itself, the CPU 110 executes the corresponding application. Otherwise if the application is of being processed by the GPU 120, the CPU 110 generates a binary corresponding to the application to the GPU 120.

Since the processing unit to execute an application is selected based on the allocation index calculated using the weight configured for the application, the CPU 110 may adjust the workloads of the CPU 110 and GPU 120.

The GPU 120 performs the function of processing graphics of the terminal That is, the GPU 120 may perform graphic operations related to various data being displayed on the display unit. In the present invention, the GPU 120 may execute the corresponding application with binary transferred by the CPU 110.

The storage unit 130 stores the data generated according to the operation and state of the terminal Here, the storage unit 130 stores the workload balancing information table 135. The workload balancing information table 130 includes several weights for the corresponding application. For example, the workload balancing information table 135 includes the weight for the workload, weight for data size of application, and weight for application task to be processed by the CPU 110 or GPU 120, when the CPU 110 or GPU 120 processes the corresponding application.

The workload balancing information table 135 includes the priority processing modes and per-mode processing threshold values. The priority processing modes may be expressed as F mode and T mode. The per-mode threshold values may be classified into fairness threshold value and throughput threshold value. The processing threshold value to be compared with the allocation index may be the fairness threshold value for the F mode and the throughout threshold value for the T mode.

Although not shown in the drawing, the terminal may further include various components required depending on the function supported by the terminal such as an input unit for receiving the command input by the user, a display unit for displaying the data generated depending on the operation and state of the terminal, and a communication unit for communicating data with the outside.

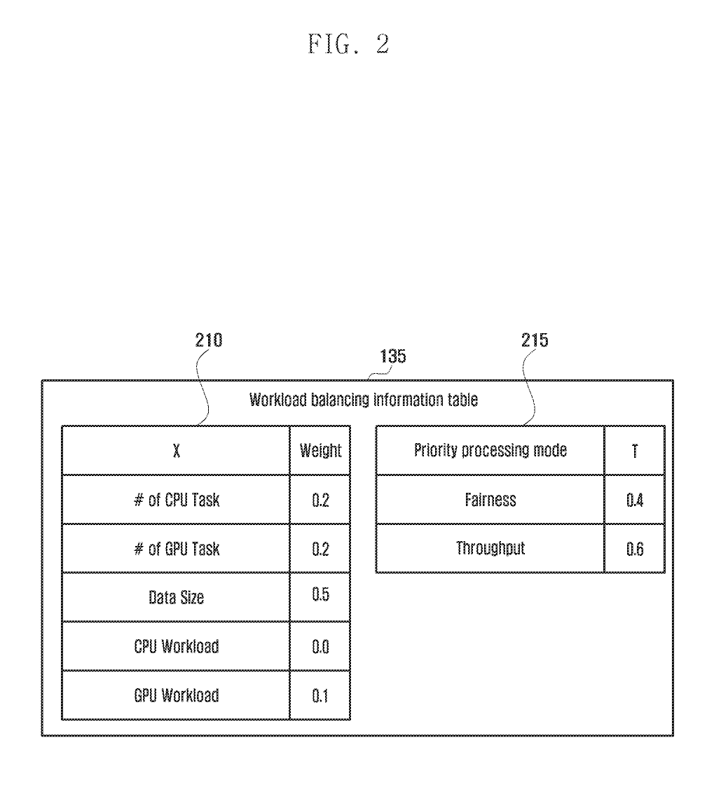

FIG. 2 is a diagram illustrating the workload balancing information table according to an embodiment of the present invention.

Referring to FIG. 2, the workload balancing information table 135 may include weight information 210 concerning the application and priority mode information 215 for selecting a processing unit to which the application is allocated.

The weight information 210 includes the condition (X) for executing the application and weight values. The application execution condition (X) includes # of CPU tasks, # of GPU tasks, data size, CPU workload, and GPU workload. The # of CPU tasks or # of GPU tasks denotes the processing unit for executing the corresponding application in CPU or GPU. The CPU workload and GPU workload denote the workloads processed by the CPU and GPU. At this time, each condition is configured with an index.

According to the weight information 210, the weight is configured for each condition. For example, as shown in FIG. 2, the weight of # of CPU task may be 0.2, the weight of # of GPU task may be 0.2, the width of data size may be 0.5, the weight of CPU workload may be 0.0, and the width of GPU workload may be 0.1. The index and weight of each condition may be modified or deleted by the use depending on the characteristics of the terminal or configured by the terminal manufacturer. The per-condition weights are exemplified for explanation convenience but not limited thereto.

The priority processing mode information 215 is the information on the mode for determining the processing unit which executes the corresponding application. That is, the priority processing mode is the mode for selecting the processing threshold value preconfigured for determining whether to allocate the selected application to the CPU or GPU. Here, the priority processing mode may be classified into one of F mode and T mode, the F mode for selecting a processing unit in consideration of application execution speed and the T mode for selecting a processing unit in consideration of load balancing in executing the application.

According to the priority processing mode, the processing threshold value may include two threshold values that are referred to as fairness threshold value and throughput threshold value respectively. The fairness threshold value is used in the F mode and configured according to the execution speed of the corresponding application. The throughput threshold value is used in the T mode and configured in consideration of the load balancing of the CPU and GPU. Since the processing threshold is configured per priority mode, the processing unit for executing the corresponding application may change depending on the priority processing mode. Accordingly, the terminal may allocate the workload to the CPU and GPU at the same level based on the processing threshold value.

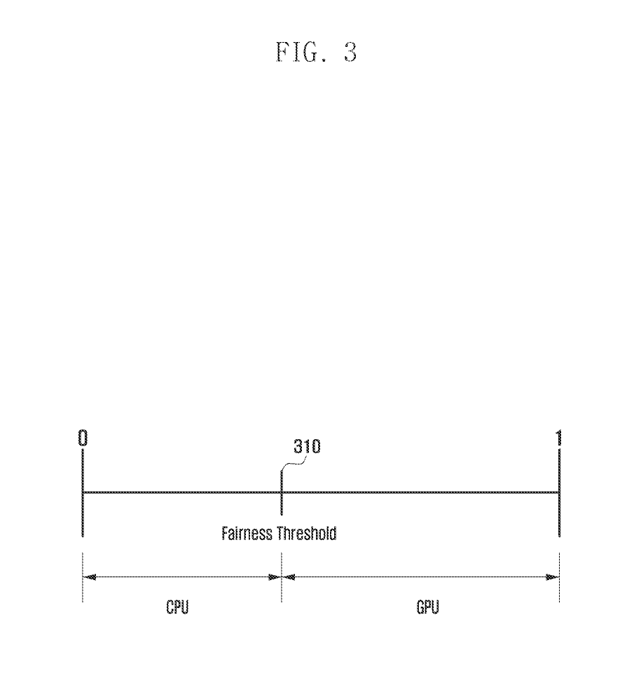

FIG. 3 is a diagram illustrating workloads of the application which is allocated in a first priority mode according to an embodiment of the present invention. In more detail, FIG. 3 is a diagram illustrating the workloads allocated to the CPU and GPU when the F mode is configured as the priority mode.

If the priority mode is the F mode, this means that the workload is allocated to the CPU and GPU based on the fairness threshold value 310. The fairness threshold value 310 is the threshold value configured in consideration of the execution speed of the corresponding application.

Referring to FIG. 3, the workload processed by the GPU is greater than the workload processed by the CPU on the basis of the fairness threshold value 310. Since the GPU is a multicore GPU capable of processing allocated tasks in parallel, its processing speed is fast. Accordingly, in the case of configuring the priority mode based on the fairness threshold value 310, the more workload is allocated to the processing unit having fast application execution speed.

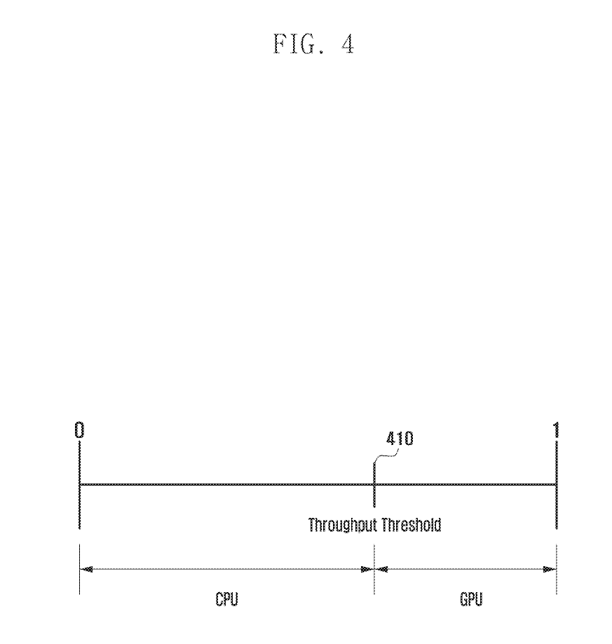

FIG. 4 is a diagram illustrating workloads of the application which is allocated in the second priority mode according to an embodiment of the present invention. In more detail, FIG. 4 is a diagram illustrating the workloads allocated to the CPU and GPU when the T mode is configured as the priority mode.

If the priority mode is the T mode, this means that the workload is allocated to the CPU and GPU based on the throughput threshold value 410. The throughput threshold value 410 is the threshold value configured in consideration of the load balancing of the CPU and GPU.

Referring to FIG. 4, the workload processed by the CPU is greater than the workload processed by the GPU on the basis of the throughput threshold value 410. Since the CPU controls the states and operations of all components constituting the terminal, the workload to be processed by the CPU is greater than that of the GPU fabricated for processing graphics. Accordingly, in the case that the priority mode is configured based on the throughput threshold value 410, the more workload is allocated to the processing unit having large workload of processing the application.

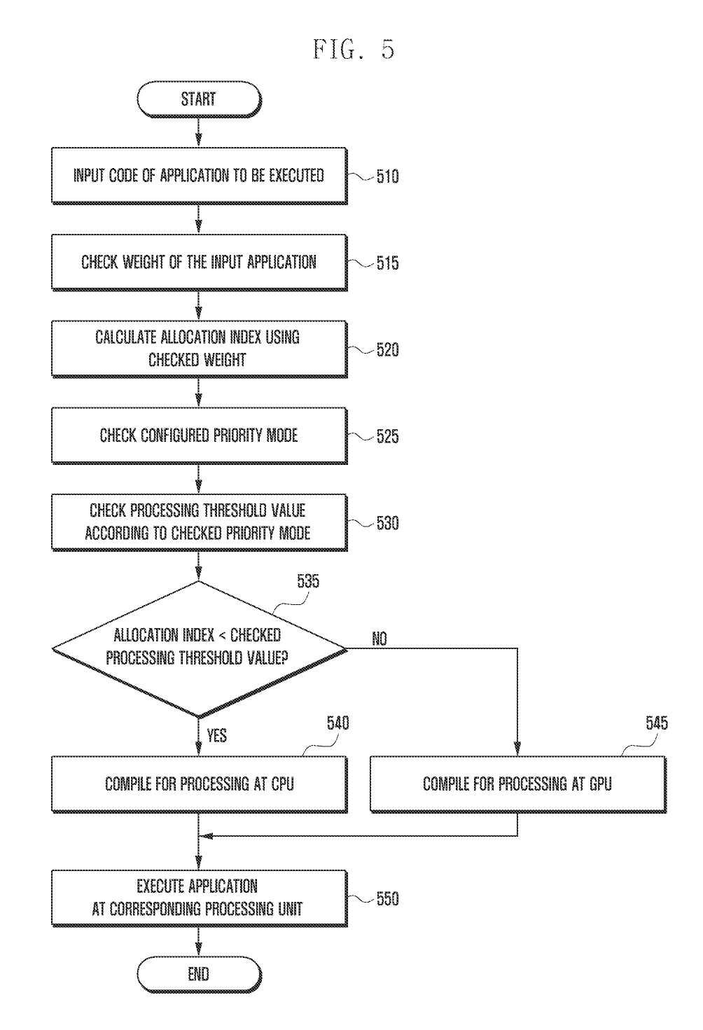

FIG. 5 is a flowchart illustrating an application execution method according to an embodiment of the present invention.

Referring to FIG. 5, if a code for the application to be executed is input at step 510, the terminal checks the weight of the input application at step 515. Here, the weight is checked by referencing the preconfigured workload balancing information table. The workload balancing information table includes a plurality of weights concerning the corresponding application. For example, the workload balancing information table includes workload weight when the application is processed by the CPU or GPU, application data size weight, and weight of application task processed by the CPU or GPU.

Next, the terminal calculates and allocation index using the checked weight at step 520. At this time, the allocation index is a value in the range from 0 to 1. The terminal checks the configured priority mode at step 525.

The priority mode is the mode for selecting the processing threshold value for use in determining whether to allocate the corresponding application to the CPU or the GPU. The processing threshold value includes at least two threshold values of fairness threshold values and throughput threshold value. The processing threshold value for determining the processing unit to process the corresponding application varies depending on the priority mode. For example, if the priority processing mode is the F mode, the fairness threshold value is selected as the processing threshold value. Otherwise, if the priority processing mode is the T mode, the throughput threshold value is selected as the processing threshold value.

The terminal checks the processing threshold value in accordance with the priority mode at step 530. The terminal determines whether the calculated allocation index is less than the processing threshold value at step 535. If the allocation index is less than the processing threshold value, the terminal performs compiling for processing at the CPU at step 540. That is, the terminal compiles the application in to the binary for CPU. Otherwise if the allocation index is equal to or greater than the processing threshold value, the terminal reads the binary of the application for GPU at step 545. At this time, if there is no binary for GPU, the application is compiled to the target code to be processed by the GPU so as to generate the binary. The terminal executes the application by means of the corresponding processing unit at step 550. That is, the terminal processes the application by means of the GPU using the target code for pressing at the CPU. The terminal also processes the corresponding application by means of the GPU using the target code for being processed at the GPU.

Through the above procedures, it is possible to allocate workload depending on the statuses of the CPU and GPU. If the workload increases at one of the CPU and GPU, the task is allocated to the other, resulting in improvement system efficiency.

Although the description has been made with reference to particular embodiments, the present invention can be implemented with various modifications without departing from the scope of the present invention. Thus, the present invention is not limited to the particular embodiments disclosed but will include the following claims and their equivalents.

1. An application execution method of a terminal having a central processing unit and a graphics processing unit, the method comprising:
calculating an allocation index using a weight of an application to be executed;
selecting one of the central and graphics processing units to execute the application based on the allocation index; and
executing, at the selected processing unit, the application.

2. The method of claim 1, wherein the calculating of the allocation index comprises:
checking, when a code of the application to be executed is input, the weight of the application; and
calculating the allocation index using the checked weight.

3. The method of claim 2, wherein the selecting of one of the processing units comprises:
checking a priority processing mode for selecting the processing unit to which the application is allocated and a processing threshold value according to the priority processing mode; and
selecting the processing unit by comparing the checked processing threshold value and the allocation index.

4. The method of claim 3, wherein the selecting of one of the processing units comprises compiling, when the allocation index is less than the processing threshold value, the code of the application in order for the central processing unit to process the application.

5. The method of claim 4, wherein the selecting of one of the processing units comprises compiling, when the allocation index is equal to or greater than the processing threshold value, the code of the application in order for the graphic processing to process the application.

6. The method of claim 5, wherein the priority processing mode comprises at least two modes.

7. The method of claim 6, wherein the processing threshold value is configured per mode.

8. The method of claim 7, wherein the weight is configured for at least one of task processed for executing the application by one of the central processing unit and graphic processing unit, data size, central processing unit workload, and graphics processing unit workload.

9. A terminal for executing an application, the terminal comprising:
a storage unit which stores data;
a central processing unit which calculates an allocation index using a weight of an application to be executed and selects one of the central and graphics processing units to execute the application based on the allocation index; and
a graphics processing unit which executes the application using a binary transmitted by the central processing unit.

10. The terminal of claim 9, wherein the storage unit stores a workload balancing information table, and the central processing unit checks, checking, when a code of the application to be executed is input, the weight of the application and calculates the allocation index using the checked weight.

11. The terminal of claim 10, wherein the central processing unit checks a priority processing mode for selecting the processing unit to which the application is allocated and a processing threshold value according to the priority processing mode and selects the processing unit by comparing the checked processing threshold value and the allocation index.

12. The terminal of claim 11, wherein the central processing unit compiles, when the allocation index is less than the processing threshold value, the code of the application in order for the central processing unit to process the application.

13. The terminal of claim 12, wherein the central processing unit compiles, when the allocation index is equal to or greater than the processing threshold value, the code of the application in order for the graphic processing to process the application.

14. The terminal of claim 13, wherein the priority processing mode comprises at least two modes.

15. The terminal of claim 14, wherein the processing threshold value is configured per mode.

16. The terminal of claim 15, wherein the weight is configured for at least one of task processed for executing the application by one of the central processing unit and graphic processing unit, data size, central processing unit workload, and graphics processing unit workload.
